(19) United States
(12) Patent Application Publication
(10) Pub. No.: US 2018/0341873 A1
(43) Pub. Date: Nov. 29, 2018

(54) ADAPTIVE PRIOR SELECTION IN ONLINE EXPERIMENTS

(71) Applicant: Streamlet Data, La Jolla, CA (US)

(72) Inventor: Ian Edward Fellows, La Jolla, CA (US)

(21) Appl. No.: 15/987,502

(22) Filed: May 23, 2018

Related U.S. Application Data
(60) Provisional application No. 62/510,712, filed on May 24, 2017.

(51) Int. Cl. G06N 5/04; G06N 7/00

(52) U.S. Cl. CPC G06N 5/048; G06N 7/005

(57) ABSTRACT

New methodologies related to experimentation and optimization include using historical data from past experiments, important distributional parameters are estimated, allowing the display of vastly more accurate analytics. Scalability to big data systems is implemented via a limited information likelihood approximation. One example application includes performing online experiments including testing website preferences of visitors.

### PRIORITY CLAIM

This patent document claims the benefit of priority of U.S. Provisional Patent Application No. 62/510,712, filed on May 24, 2017. The entire content of the before-mentioned patent application is incorporated by reference herein.

### BACKGROUND

Web technologies have become an indispensable part of today's life for delivering information, conducting collaborative research, e-commerce applications, and entertainment, to name a few. User satisfaction often depends on the responsiveness of web servers and the format in which the information is presented. Efficient operation of web servers in turn depends on streamlining the number of web pages presented and the format in which the web pages are presented to the users.

### BRIEF SUMMARY

The document describes, among other things, techniques for performing experimental optimization for web content. Unlike prior art techniques, which lacked the ability to tailor analyses based on past test performance, the embodiments disclosed herein can adapt to the types and sizes of effects seen in past experiments.

Some embodiments include application of Bayesian analysis to online experimentation, and an aspect of this system is the overcoming of the limitation of fixed priors. Some implementations may select past experiments from among those that have been run in the past, and uses them to estimate the true prior distribution.

Some embodiments include the ability to perform this prior estimation in a scalable manner using the “limited information” likelihood described in detail below.

In one example aspect, a computer implemented method is disclosed. The method includes a) storing historical data from experiments, and b) generating, using the historical data, an estimate or a distribution of posterior reflecting a probability distribution of experimental effects given the historical data.

In another example aspect, an apparatus for performing analysis of experiments is disclosed. The apparatus includes a memory that stores computer-executable instructions and a processor that reads the instructions from the memory and implements the techniques described herein.

In another example aspect, the disclosed methods may be embodied in the form of computer-readable code and stored on a program medium.

### BRIEF DESCRIPTION OF THE DRAWINGS

For a more complete understanding, reference is made to the following description and accompanying drawings, in which:

FIG. 1 is a diagram of the Experiment Operational System.

FIG. 2 is a description of the invention implementation and data flow.

FIG. 3 is a system and data flow diagram showing how prior parameter values are estimated from historical experiment data.

FIG. 4 shows an example embodiment of an experiment optimization engine.

FIG. 5 is a block diagram of an example of an apparatus for implementing some aspects of the disclosed technology.

FIG. 6 shows a flowchart of a method of experiment optimization.

### DETAILED DESCRIPTION

To provide a satisfactory web experience to users and to streamlines the operation of web servers, web sites are often looking for ways by which to understand what a user wants and how to provide information in a way that users will find attractive. Such improvements by web servers not only can improve user experience, but also improve the efficiency of operation by possibly reducing web traffic and the amount of computational and storage resources needed by a web server.

A/B Testing has a ubiquitous presence in the world of online marketing and is a standard tool used to optimize the performance of websites, Ad content, e-mail campaigns, and other content.

An A/B test is a multi-arm randomized controlled trial comparing a number of different versions of a page or site (known as variants) to one another on an outcome metric that may be binary, ordinal or continuous. Particular attention is put on the case of a binary outcome metric, which usually represents a “Conversion” (e.g. A user signed up for a service, clicked an Ad, or bought an item).

When testing which variation of a web page achieves a given objective, e.g., conversion, the AB test may be used to collect data about resource utilization and/or user behavior for various versions of a web page. Decisions regarding user preferences and efficiency of operation are made on a streaming, or ongoing, basis. Because data is observed sequentially, and decision making is done in an ongoing basis, rather than once a proscribed sample size is reached, typical statistical methods of analysis may yield invalid results. The inaccuracy in results may occur due to early termination of the version testing, or may occur because the decision drawn from the number of observations made may be inaccurate. Broadly speaking, the decisions may be made during such online experimentation using hypothesis testing or Bayesian testing.

This standard problem is one of the fundamental use cases for Bayesian analysis, and thus has had a great deal of attention focused on it. In a Bayesian analysis, the analyst begins with a prior understanding of the effects of interest, for example the likely conversion rates of the different variants, and then updates this understanding based on the results from the experiment. This updated understanding is known as the posterior distribution, which is used to perform inference discriminating between the variants and make decisions about test termination.

Prior work in the Bayesian analysis online experiments has used non-informative or flat prior distributions. Examples of this include “Google Experiments” and “ABTasty.” However, because these priors are chosen arbitrarily without regard to the actual environment of the experiment, they are, for lack of a better word, incorrect. What is needed is a system that actively adapts prior beliefs based on past experiments performed through the system.

The solutions provided in the present document can be used performing experimental optimization for web content. While previous systems have lacked the ability to Taylor analyses based on past test performance, some implementations disclosed herein can adapt to the types and sizes of effects seen in past experiments. Certain aspects of the technology are described with reference to application to web-based experimentation only for illustrative purpose. The described techniques can be used in other application areas as well. Some example applications include predicting results of sports games, election results, determining newspaper or print magazine layouts, and so on.

In one example aspect, some implementations may apply Bayesian analysis to online experimentation, and overcome the limitation of fixed priors. Some embodiments select past experiments from among those that have been run in the past, and uses them to estimate the true prior distribution.

Another aspect of some embodiments is the ability to perform this prior estimation in a scalable manner using the “limited information” likelihood described in detail below.

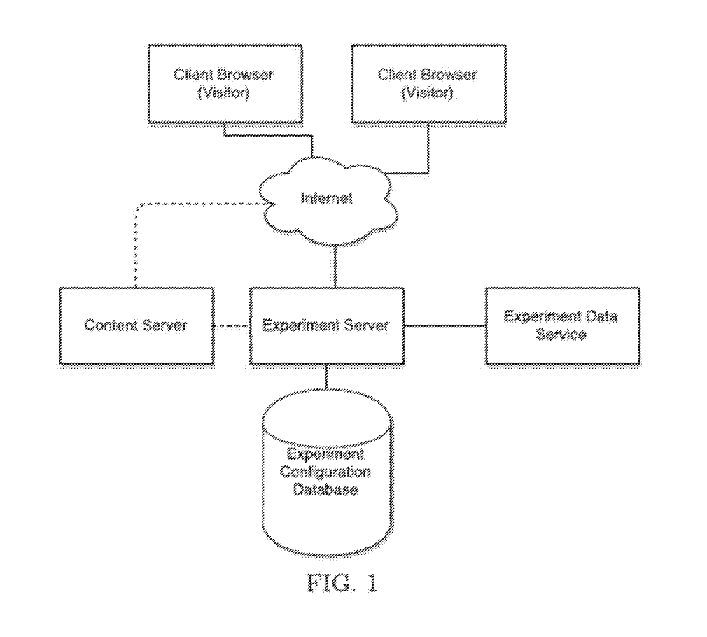

FIG. 1 shows the Experiment Operational System. In this system the user experience for a visitor to a web site is determined in part by general content, and in part by a randomized experiment.

The Content Server is a web server providing the default experience for visitors of a web site. This content is generally served to client browsers through the Internet (or alternatively another network system) In the case of an experiment, the content provided by the server is mediated by the Experiment Server.

The Experiment Server is a web service, providing an application program interface (API) which determines, based on variables such as browsing history and visitor attributes, whether a particular visitor is eligible for enrollment in each experiment. If a visitor is eligible, then the server randomizes them (through the use of a pseudo-random number generator) to one of several variants (also known as arms of the experiment) of the default user experience. Both the conditions for enrollment and the results of the randomization are stored in the Experiment Configuration Database, which is implemented as a scalable MongoDB database.

In a server side content experiment, the content server changes the user experience it serves to the visitor clients based on the randomization. In a client side content experiment, the content server adds javascript instructions to visitors' content for them to query the experiment server for additional content. The Experiment server, based on the results of the randomization, sends the visitor clients javascript code that alters their experience to the desired variant of the default.

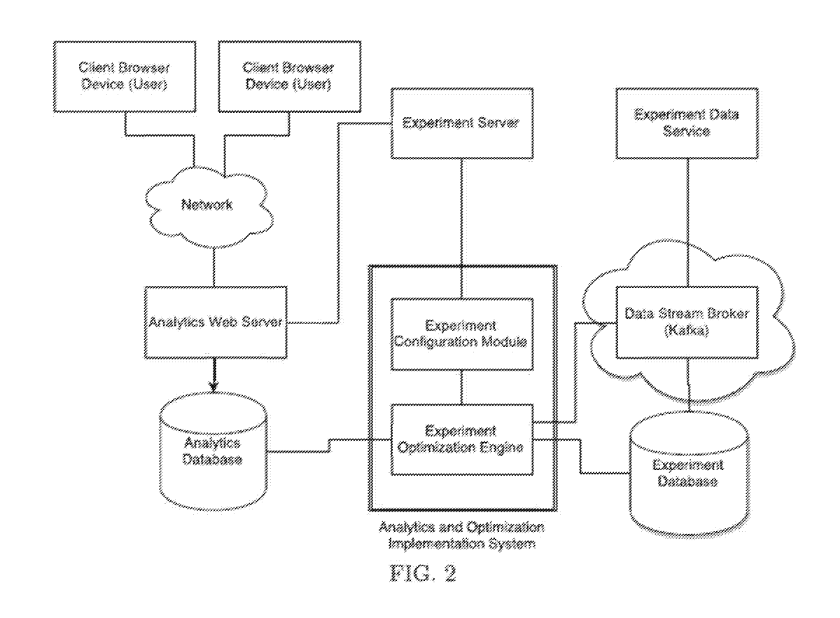

As Visitors navigate the web site and are randomized, their data is put on the Experiment Data Service stream, which is a producer to the Data Stream Broker (see FIG. 2). This data includes website performance indicators such as whether the visitor “Converted,” how much time they spend on the site, and how much money the visitor spent on the site. The data also includes the randomization assignments for the visitor, and additional attributes such as visitor location or time of day.

FIG. 2 shows the structure of the analytics system used to provide optimization results to users for their experiments.

As the Experiment Data Service forwards the experimental data to the Data Stream Broker. The Data Stream Broker, implemented as a Kafka distributed streaming platform, mediates the interactions between this data stream and various consumers of the stream. One of these consumers is responsible for storing the data into the Experiment Database.

The Experiment Database is a long term storage system for raw experiment data. This is implemented as scalable MongoDB cluster.

The Experiment Optimization Engine takes the user data stream from the Data Stream Broker and from the Experiment Database. It applies Bayesian analysis to the desired key performance indicators using prior parameters estimated from previous experiments (described in detail below, and stored in the Prior Analytics Database), and forwards the results to the Analytics Database. The Analytics Database is implemented as a scalable MongoDB cluster and houses processed analytical results such as posterior probabilities parameter estimates and parameter covariance matrices.

The Analytics Web Server uses the results created by the Experiment Optimization Engine to display the results to the user so that they may make optimal decisions regarding whether to terminate the test, and which variant to choose on an ongoing basis. Alternatively, if the experiment was set up as an automated test, the Analytics Web Server communicates directly with the Experiment Server, providing the decision to continue the test, alter it, or terminate and accept a variant.

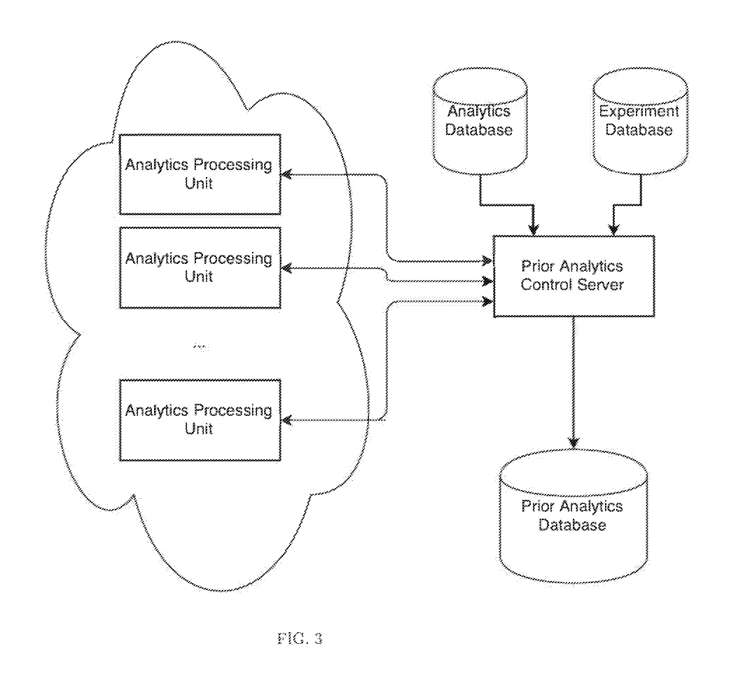

FIG. 3 provides a diagram of the system flow for prior parameter calculation. The raw visitor data is stored within the Experiment Database, and the Analytics Database contains processed data summaries, calculated in the course of providing analytics to the user (see FIG. 2). For example, the maximum likelihood estimates and Fisher information matrices for the parameters of interest are stored here.

The Prior Analytics Controller Server queries data from the two storage systems for use in the calculation. It chooses a set of past experiments to use in the calculation. If the full likelihood method is employed, then raw experimental is queried. If the limited information likelihood method is employed, then only data from the Analytics Database is needed.

Given this data, the Prior Analytics Control Server sends the data, along with computational instructions to an Analytics Processing Unit. The Analytics Processing Units are independent computational servers located in a cloud computing environment that perform the prior parameter computations. The content of these computations are described in detail below.

Once computations are complete, they are returned to the Prior Analytics Control Server, which stores the results in the Prior Analytics Database. The Prior Analytics Database is implemented as a Mongo database. These new prior parameter values may then be used by future experiments.

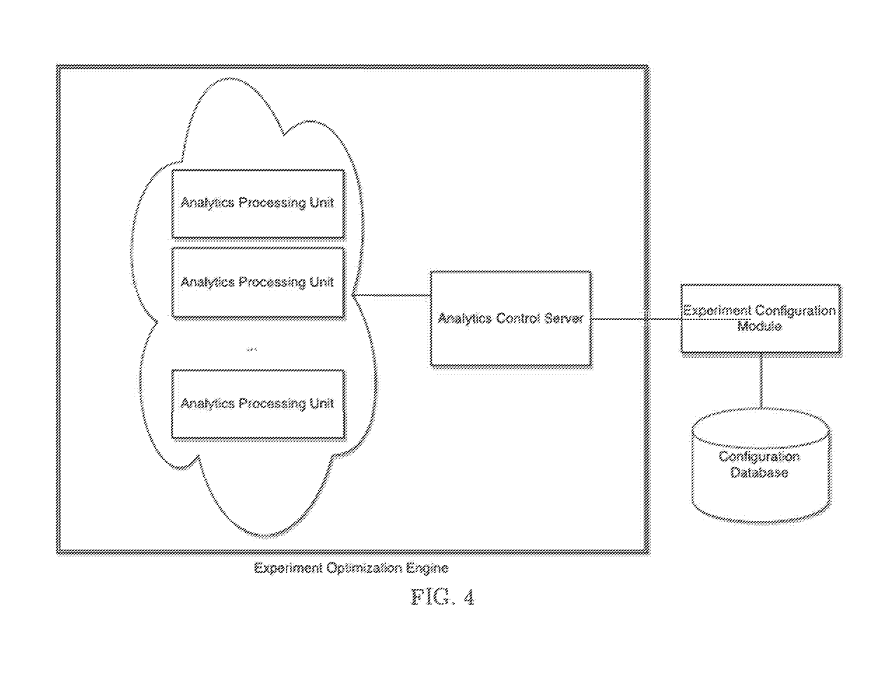

FIG. 4 shows a detailed view of the Experiment Optimization Engine. The Analytics Configuration Module provides mechanisms for storing and changing configuration parameters for experimental tests. This includes values controlling the prior distribution parameters. The Analytics Control Server takes the configuration parameters and data from experiments, and dispatches the computation to an Analytics Processing Unit. The Analytics Processing Units are a scalable cloud of worker systems that perform the computationally intensive analytics for each individual experiment.

The remainder of the description provides a detailed account of the computations used by the Analytics Processing Units to generate prior parameter estimates.

Let Xᵢ be the experimental data for past test i∈{1, . . . , n}, with realization xᵢ. The distribution is where θᵢ is a vector of parameters of interest for that test. For example, 0 may indicate the population proportions of the different variants for binary outcomes, or population means and variances for continuous data.

Suppose that π(θᵢ|μ) is the prior distribution of θᵢ. The goal of the adaptive prior method is to find the true value of μ.

The posterior distribution of θᵢ for a particular test is

p(θᵢ|xᵢ,μ)∝p(xᵢ|θᵢ)π(θᵢ|μ). (1)

and this is the distribution that is used to perform inference about the experiment.

Further suppose that we specify a prior distribution π(μ) on μ. The posterior distribution of μ and θ taking into account all experiments is then

$$p ( μ , θ \vert x ) ∝ π ( μ ) {\prod }_{i = 1}^{n} p ( {x}_{i} \vert {θ}_{i} ) π ( {θ}_{i} \vert μ ) . \qquad ( 2 )$$

This posterior distribution may be used in two ways to choose what μ values to use in future experiments. First, Equation 2 may be maximized to achieve the maximum a posterior value

$${\hat{μ}}_{MAP} = arg {max}_{μ} {max}_{θ} π ( μ ) {\prod }_{i = 1}^{n} p ( {x}_{i} \vert {θ}_{i} ) π ( {θ}_{i} \vert μ ) . \qquad ( 3 )$$

Alternatively, the mean or median of the posterior are used. These can either be calculated mathematically from the distribution function, or we use sampling to obtain approximations. k posterior samples μ(1), . . . , μ(k) are drawn from the distribution. One method of performing this sampling is Markov Chain Monte Carlo (MCMC) utilizing software such as Stan or JAGS. The mean estimate of μ is then

$${\hat{μ}}_{MEAN} = \frac{1}{k} {\sum }_{i = 1}^{k} {μ}^{( i )} , \qquad ( 4 )$$

and the median is

\hat{μ}_{MEDIAN}=median(μ⁽¹⁾, . . . ,μ^{(k)}). (5)

Another feature supported is the ability to perform scalable prior estimation. As the number of experiments increases, the computational cost of keeping all xᵢ in memory becomes prohibitive. This can make posterior inference for μ computationally prohibitive. Instead of considering the full distribution of xᵢ, an aspect of this method uses the sampling distribution of the population parameters for inference.

Let \hat{p}(\hat{θ}ᵢ|θᵢ) be an approximate distribution for some parameter estimates \hat{θ}ᵢ. For example, If \hat{θ} are the maximum likelihood estimates, then

\hat{p}(\hat{θ}ᵢ|θᵢ)=ϕ(\hat{θ}ᵢ|θᵢ,Îᵢ⁻¹) (6)

is the approximate distribution, where ϕ is the normal density function, and Îᵢ is the estimated fisher information matrix. This is the “limited information” likelihood.

Given the limited information likelihood, we are able to estimate the posterior for μ as

$$p ( μ , θ \vert \hat{θ} ) ∝ π ( μ ) {\prod }_{i = 1}^{n} \hat{p} ( {\hat{θ}}_{i} \vert {θ}_{i} ) π ( {θ}_{i} \vert μ ) . \qquad ( 7 )$$

MAP, mean and median estimates for μ are calculated analogously to the full likelihood case.

Additionally, Equation 1 may be altered to utilize the limited information likelihood

p(θᵢ|\hat{θ}ᵢ,μ)∝\hat{p}(\hat{θ}ᵢ|θi)π(θᵢ|μ). (8)

Alternately, instead of estimators, the distribution of summary statistics may be used to reduce the computational burden. For instance, if the xᵢ are Bernoulli random variables with success probability depending on variant and θᵢ, then

p(xᵢ|θᵢ)∝p(sᵢ,nᵢ|θᵢ), (9)

where sᵢ is a vector representing the number of positive outcomes among visitors of each variant, and nᵢ is the number of visitors exposed to each variant. Utilizing this simplification reduces the storage requirement, as only sᵢ and nᵢ are needed for each experiment in order to estimate the prior parameters.

Another aspect of the invention is the ability to estimate different values of μ based on the values of covariates. For example, different customers may end to have larger or smaller deviations between variations in their experiments. One customer may tend to make bold changes to their content, leading both to large increases or decreases in conversion rates between variants. Another customer may be more conservative, making only minor changes that have small effects.

Let c(i) indicate the customer associated with experiment i, μⱼ for j∈{1, . . . , r} be the value of μ for customer j, and τ be a set of hyper-parameters. The posterior is then

$$p ( τ , μ , θ \vert x ) ∝ π ( τ ) ( {\prod }_{j = 1}^{r} π ( {μ}_{j} \vert τ ) ) {\prod }_{i = 1}^{n} p ( {x}_{i} \vert {θ}_{i} ) π ( {θ}_{i} \vert {μ}_{c ( i )} ) , \qquad ( 10 )$$

where π(τ) is a prior distribution over the hyper-parameters.

Let us now describe a particular instantiation of the method. Suppose that we have an a/b test with conversions as the outcome, and that there exist important covariates affecting the conversion rate, such as the time of day. We model the probability that the dth visitor of experiment i converted as a logistic regression

log it(p(xᵢ^{d}|θᵢ,βᵢ))=θᵢ·yᵢ^{d}+βᵢ·zᵢ^{d}, (11)

where y_{d}ⁱ is a dummy coded representation of the variant of visitor d in experiment i and zᵢ^{d} are the additional covariates including an intercept variable.

Maximum likelihood is then performed on this logistic model in each experiment to yield the limited information likelihood

\hat{p}(\hat{θ}ᵢ|θᵢ)=ϕ(\hat{θ}ᵢ|θᵢ,Îᵢ⁻¹). (12)

The distribution for θ is chosen to be normal centered on 0

π(θᵢ|μ_{c(i)})=ϕ(θᵢ|0,μ_{c(i)}), (13)

and the distributions of the μ_{c(i)} are log-normal with location parameter τᵢ and scale parameter τ₂

π(μⱼ|τ)=log normal(μⱼ|τ₁,τ₂²), (14)

where log normal is the log-normal density.

The prior on τ is chosen to be uniform π(τ)∝1.

With the distributions specified, the posterior is then

$$p ( τ , μ , θ \vert x ) ∝ ( {\prod }_{j = 1}^{r} lognormal ( {μ}_{j} \vert {τ}_{1} , {τ}_{2}^{2} ) ) {\prod }_{i = 1}^{n} φ ( {\hat{θ}}_{i} \vert {θ}_{i} , {\hat{I}}_{i}^{- 1} ) φ ( {θ}_{i} \vert 0 , {μ}_{c ( i )} ) . \qquad ( 15 )$$

Markov Chain Monte Carlo is then performed on this posterior to generate simulated values for μ. The mean of these simulations within each customer is used as the prior parameters for that customer's new experiments.

Once the prior parameter values (μ) have been estimated, future tests use the values with Equation 1 to perform inference. And users of the system use Equation 1 or simulations from the posterior to decide if the test should be terminated or altered, and which arm is the best. Alternatively, the system can provide a closed loop feedback to the External Test Controller (see FIG. 2), to automatically execute decision rules.

The most important quantity for performing decision making in online testing is the posterior probability that an arm (j) is better than all other arms (α^{j}) at the current time. For example, if θᵢ^{j} represents the probability of conversion for the jth arm in the ith experiment, then the probability of interest is

α^{j}=p(j is best)=p({θ:θᵢ^{j}>θᵢ^{l}∀l≠j}). (16)

There are many rules that can be implemented based on the posterior. One such rule is to terminate the test when the maximum probability exceeds a threshold

max(α^{j})>1−∈, (17)

where ∈ is the desired error rate (often 5%).

As the experiment progresses it may also be altered so that amount of visitor traffic allocated to each variant (arm) changes over time. One rule for setting traffic rates is the Thompson sampling rule. If α^{j} is the allocation for each variant, then Thompson sampling sets this at

α^{j}←α^{j}. (18)

Alternately, for best arm identification they can be set at

$${a}^{j} ← {α}^{j} ( β + ( 1 - β ) {\sum }_{l \neq j} \frac{{α}^{l}}{1 - {α}^{l}} ) , \qquad ( 19 )$$

where β is typically set to 0.5.

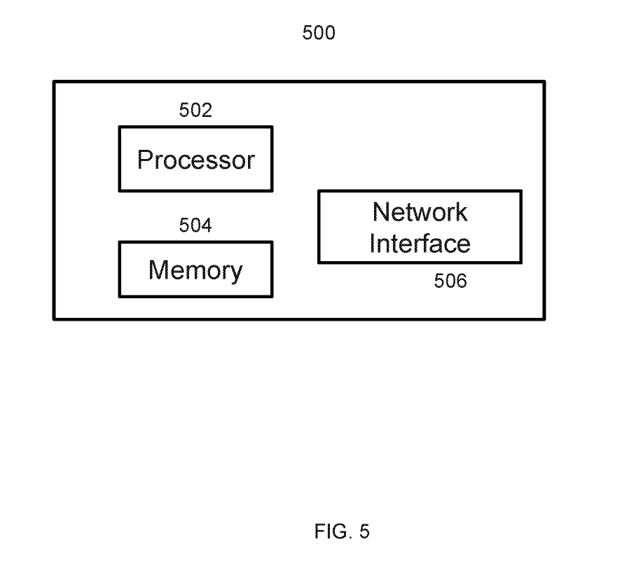

FIG. 5 shows an example apparatus 500 in which the techniques described in the present document can be embodied. The apparatus 500 includes a processor module 502 that includes one or more CPUs. The apparatus includes a memory module 504 that includes one or more memories. The apparatus may also include a network interface 506 using which the apparatus 500 may be able to communicate with other network equipment. Other optional interfaces such as human interaction interface, display interface, and so on are omitted from the drawing for brevity.

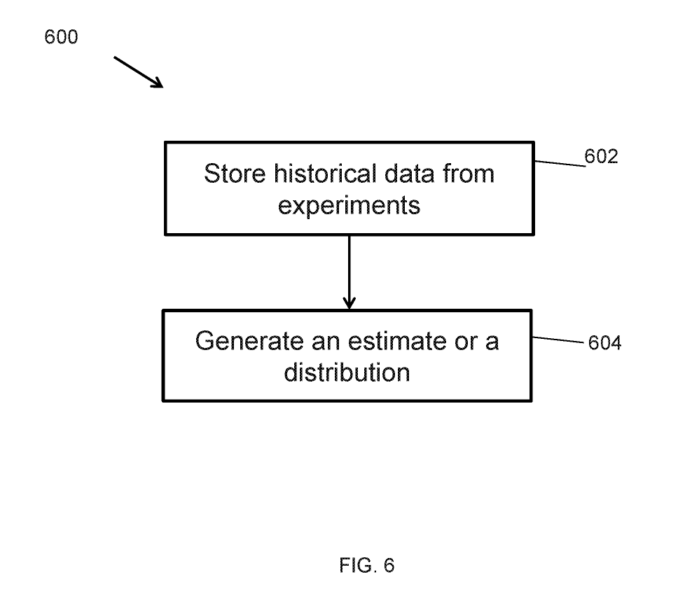

FIG. 6 is a flowchart showing an example method 600 of performing experiments. The method 600 may be implemented by an apparatus as described with respect to FIG. 5. The method 600 includes, at 602, storing historical data from experiments. For example, the experiments may include online experiments in which web sites are trying to find user preference and improve operations of storing and serving web pages to users.

At 604, using the historical data, an estimate or a distribution of posterior reflecting a probability of distribution of experimental effects given the historical data is generated. In some embodiments, the method 600 may further include utilizing the distribution or the estimate to perform further analysis about the experiments. Some embodiments may further calculate the posterior of the experimental effect of the estimate.

In various embodiments, as described in the present document, the estimates are calculated using a maxima, a mean or a median of the posterior values.

In some embodiments, the method 600 may use an approximate probability distribution of a transformation instead of an analytical form of a probability distribution. The transformation may be, e.g., a maximum likelihood transformation or a summary statistic transformation.

In some embodiments, the method 600 may further include calculating the estimate of the distribution conditional upon a set of auxiliary attributes of the experiment or a visitor. For example, in some embodiments, the auxiliary attribute may be the customer (as captured by an identity of a user).

The method 600 may automatically terminate the experiment, or adjust traffic allocation to the various experimental parameters in the experiments. For example, in some implementations, n different user options may be provided on a home page to different users. After the analysis reaches a statistically stable point, the website may decide on a “winner” home page and terminate the experiment. Alternatively, if user selection of one particular parameter is (e.g., play a video) causing traffic imbalance among the various web page options, then the method 600 may adjust traffic such that more traffic is allocated to the experimental parameters that use greater traffic. For example, in some embodiments, the experiments are terminated when a posterior probability that a variant is best exceeds a specified value. In some implementations, as previously discussed, the traffic allocation rates are adjusted using the experiment's posterior distribution p(θᵢ|xᵢ,μ)∝p(xᵢ|θᵢ)π(θᵢ|μ); wherein p represents a distribution function, θᵢ is a vector of parameters of interest, xᵢ represents a realization off experimental data and i is an index of past tests, and π(θᵢ|μ) the prior distribution of θᵢ.

In some embodiments, the traffic allocation rates to each variant (e.g., different home pages) may be altered to be proportional to that particular variant or arm of a decision tree is deemed to be the best (meeting a certain optimization criteria such as web server operating efficiency).

In some embodiments, the traffic allocation rates are set according to

$${a}^{j} ← {α}^{j} ( β + ( 1 - β ) {\sum }_{l \neq j} \frac{{α}^{l}}{1 - {α}^{l}} ) ,$$

where a^{j} is an allocation for a variant, β is a variable and

α^{j}=p(j is best)=p({θ:θᵢ^{j}>θᵢ^{j}>θᵢ^{l}∀l≠j}).

where j represents an arm of the experiments, θᵢ^{j} represents the experimental effect for the for j^{th} arm in i^{th} experiment and p represents a probability of interest. Additional details are provided with respect to equations (18) and (19).

It will be appreciated that various techniques for using historical data of experiments are disclosed. It will further be appreciated that using these experiments and the disclosed techniques, some implementations may be achieved that automate the process of termination of the experiments. It will be further be appreciated that while previous technologies have lacked the ability to tailor analyses based on past test performance, techniques described herein can be used to implement embodiments that adapt to the types and sizes of effects seen in past experiments. The techniques described herein may be used by web servers to improve the performance of the web servers by continually monitoring user preferences and providing feedback to web site operators regarding allocation of server resources (e.g., memory, bandwidth, and so on) to web pages, scripts and other content hosted on the web sites. For example, the disclosed methods may be used to balance web traffic by analyzing user behavior related to which web page variants generate a greater traffic. For example, the disclosed methods may be used to optimize computing resources of a web servers such that most often used features are given preferential resource allocation over variants and features that are deemed to be less probable for usage.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed:

1. A computer implemented method, comprising:
storing historical data from experiments.
generating, using the historical data, an estimate or a distribution of experimental effects given the historical data.

2. The method of claim 1 further including:
utilizing the estimate of the distribution to perform analyses of experiments.

3. The method of claim 2 further including:
calculating a posterior of the experimental effects using the estimate of the distribution as a prior distribution.

4. The method of claim 3, wherein the estimate or the distribution is computed using maximum a posterior values.

5. The method of claim 3, wherein the estimate or the distribution is computed using a mean of the posterior.

6. The method of claim 1, wherein the estimate or the distribution is computed using a median of the posterior.

7. The method of claim 1, wherein the estimate of the distribution is computed using a probability distribution of a transformation of the data, and wherein the transformation is one of a maximum likelihood estimate transformation, or summary statistic transformation.

8. The method of claim 1, further including:
calculating the estimate of the distribution conditional upon a set of auxiliary attributes of the experiment or a visitor.

9. The method of claim 8 wherein an auxiliary attribute corresponds to a customer.

10. The method of claim 2, wherein a posterior is computed using a probability distribution of a transformation of the data, and wherein the transformation is one of a maximum likelihood estimate transformation, or summary statistic transformation.

11. The method of claim 2 further including:
automatically terminating the experiments or adjusting traffic allocation in the experiments.

12. The method of claim 11 further wherein the experiments are terminated when a posterior probability that a variant is best exceeds a specified value.

13. The method of claim 11 wherein the traffic allocation rates are adjusted using the experiment's posterior distribution p(θᵢ|xᵢ,μ)∝p(xᵢ|θᵢ)π(θᵢ|μ); wherein p represents a distribution function, θᵢ is a vector of parameters of interest, xᵢ represents a realization off experimental data and i is an index of past tests, and π(θᵢ|μ) is the prior distribution of θᵢ.

14. The method of claim 11 further wherein the traffic allocation rates to each variant are altered to be proportional to a probability that an arm is best.

15. The method of claim 11 further wherein the traffic allocation rates to each variant are set according to:
$${a}^{j} ← {α}^{j} ( β + ( 1 - β ) {\sum }_{l \neq j} \frac{{α}^{l}}{1 - {α}^{l}} ) ,$$
where a^{j} is an allocation for a variant, β is a variable and
α^{j}=p(j is best)=p({θ:θᵢ^{j}>θᵢ^{l}∀l≠j}).
where j represents an arm of the experiments, θᵢ^{j} represents the experimental effect for the for j^{th} arm in i^{th} experiment and p represents a probability of interest.

16. The method of claim 1, wherein the experiments comprise online experiments for selecting user preferences of web page presentation options.

17. An apparatus comprising a memory and a processor, wherein the memory stores computer-readable program code and the processor is configured to read from the memory and execute the code to implement a method, comprising:
storing historical data from experiments; and
generating, using the historical data, an estimate of a distribution of experimental effects given the historical data.

18. The apparatus of claim 17, wherein experiments comprise online experiments for selecting user preferences of web page presentation options.

19. A computer-readable program medium having code stored thereon, the code, when executed by a processor, causing the processor to implement an online user interaction experiment, the code comprising:
code for storing historical data from experiments; and
code for generating, using the historical data, an estimate of a distribution of experimental effects given the historical data.

20. The computer-readable program medium of claim 19, wherein the code further comprises code for automatically terminating the experiments or adjusting traffic allocation in the experiments based on the estimate of the distribution.
